(19) United States
(12) Patent Application Publication
(10) Pub. No.: US 2014/0122549 A1
(43) Pub. Date: May 1, 2014

(54) Intermediate Steps Display for a Calculator

(71) Applicant: Jonathan Gentry Ambs, Jonesboro, AR (US)

(72) Inventor: Jonathan Gentry Ambs, Jonesboro, AR (US)

(21) Appl. No.: 13/666,949

(22) Filed: Nov. 1, 2012

(51) Int. Cl. G06F 17/11

(52) U.S. Cl. CPC G06F 17/11
USPC 708/160

(57) ABSTRACT

This patent is for a device that displays the steps involved in a calculation as well as the answer of the calculation. By doing this you preserve the main benefits of the calculator (speed and accuracy) is preserved while helping the user understand how the device solved the answer. This allows the device to simultaneously serve as a calculator and a learning tool. Several embodiments for the machine are described and shown.

### CROSS-REFERENCE TO RELATED APPLICATIONS

Not Applicable

### FEDERALLY SPONSORED RESEARCH

Not Applicable

### SEQUENCE LISTING OR PROGRAM

Filled on EFS

### BACKGROUND

1. Field

This application relates to a calculator that displays the intermediate steps required to reach the answer in addition to the answer.

2. Prior Art

Since the mid 20^{th} century (U.S. Pat. No. 3,250,367) electronic calculators have been in use to facilitate solving mathematical problems. These calculators provide the correct answer to math problems with more speed and reliability than humans, but they do not provide an explanation for how the answer was derived. This has led to an increased reliance on calculators by students who do not understand the steps employed to compute the answer.

Several patents have attempted to address this need. U.S. Pat. No. 6,820,800 requires the calculator user to input at least one estimate prior to displaying the correct answer. This may make student think more about the answer, but it does not provide any assistance to users who do not understand what is occurring. It also does not prevent users from entering random numbers into the device so that it provides the correct answer. By doing this, U.S. Pat. No. 6,820,800, allows users who are not interested in learning to use this product as a regular calculator.

Application Ser. Nos. 10/886,445, 11/776,565, and 10/903,111 attempt to address this by creating programs that monitor the users work while they solve the problem. Some of these applications discuss providing users with hints if they seem confused. While this is a useful learning device, it does not provide the user with an answer. This negates one of the calculator's main benefits: its ability to solve problems faster than humans. Additionally, the approach of these patent applications tests the user's understanding of the problem without attempting to teach them the correct methods or deriving the answer.

Most users would not prefer any of the devices discussed above to a standard calculator. These prior-art solutions increase the number of steps required for the user to discover the answer, which is the primary function of a calculator. This forces the student to spend more time solving each problem. Additionally, these devices test the users' knowledge without providing instructions as to how to perform the operation more efficiently.

### SUMMARY

This application is for a calculator that displays the result to the equation as well as the intermediate steps required to solve the problem. The calculator may either be a physical machine designed only as a calculator, or a program run on a smart phone, computer, tablet, or other electronic computing device. By designing a program that displays the steps involved in a calculation as well as the answer, the main benefits of the calculator (speed and accuracy) are preserved while adding information that helps the user understand how the answer was obtained. This allows the device to serve simultaneously as a calculator and a learning tool.

### DRAWINGS

In the drawings, closely related figures have the same number but different alphabetic suffixes.

FIGS. 1A, 1B, and 1C show a possible configuration for displaying addition with the intermediate step displayed as well as the answer. Addition and subtraction may be displayed in similar ways.

FIGS. 2A, 2B, and 2C shows a possible method for displaying multiplication with the intermediate step displayed as well as the answer.

FIGS. 3A, 3B, and 3C shows a possible method of demonstrating long division with the intermediate step displayed as well as the answer.

FIGS. 4A, 4B, and 4C shows a possible method of solving a problem with multiple operations with the intermediate step displayed as well as the answer.

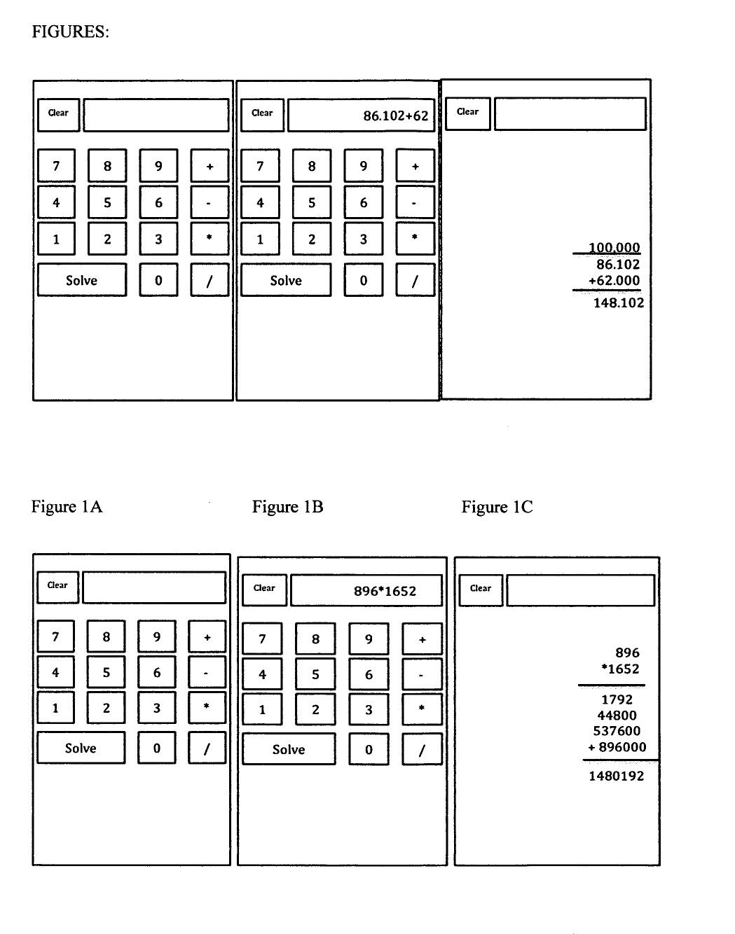

### DETAILED DESCRIPTION: FIGS. 1A, 1B, and 1C

### First Embodiment

One embodiment is illustrated in FIGS. 1A, 1B, and 1C. In these figures, a standard calculator is set up on a touch screen for a smart phone (FIG. 1A). Once the first number has been entered, the operation chosen (addition, subtraction, multiplication, or division), and the second number have been entered, the user can check to make sure the numbers were entered correctly. (FIG. 1B) By using a touch screen the size of the calculator may be minimized because when solve is pressed, all the buttons except for clear disappear, and the intermediate steps and the answer are displayed where the buttons were before (FIG. 1C).

The intermediate steps display for a calculator may also exist in several different physical states in addition to the software designed to run on a smart phone, tablet computer, personnel computer, or other electronic device. It could be an electronic calculator that contains either a single screen or multiple screens, or an additional screen that can be added to a standard electronic calculator.

### Operation

FIGS. 1A, 1B, and 1C shows a possible configuration for displaying addition with the intermediate step displayed as well as the answer. Addition and subtraction may be displayed in similar ways. The calculator in FIG. 1A shows the calculator once the software program has been started. FIG. 1B shows the two numbers (86.102 and 62) that will be added together. FIG. 1C shows the display after the equal button has been pressed on the calculator or electronic device. In this example, the lower two rows of buttons are hidden to increase the amount of screen space available for the process and the solution, and a decimal point and three 0s are added to 62 so that the unit digits align. Above the two numbers being added there is a string of numbers that show if any values were carried during the addition. At any time during the operation, the calculator can be returned to its initial configuration shown on the far left (FIG. 1A) by hitting clear.

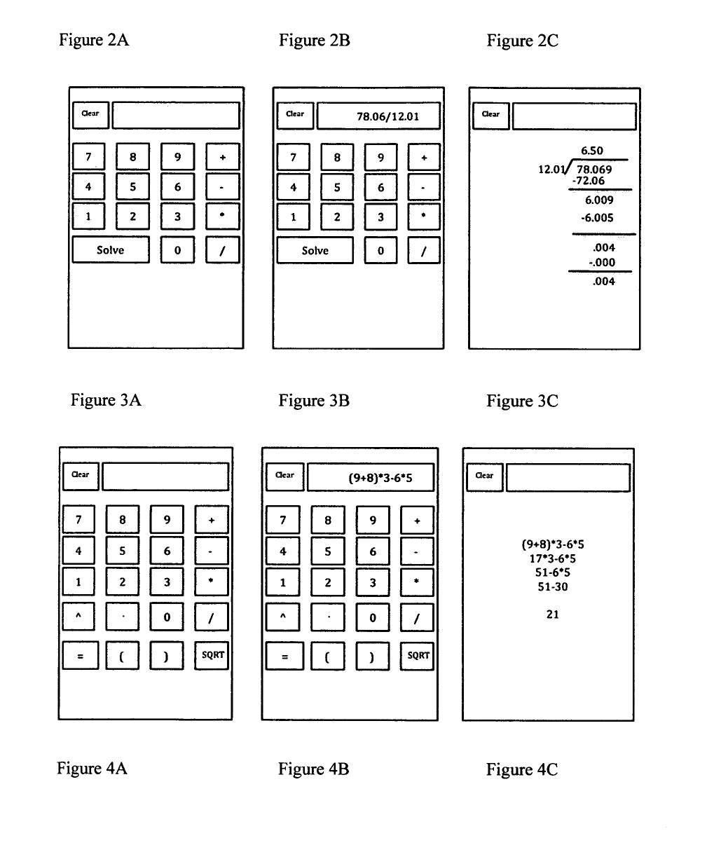

FIGS. 2A, 2B, and 2C shows a possible method for displaying multiplication with the intermediate step displayed as well as the answer. FIG. 2A shows the calculator once the software program has been started. FIG. 2B shows the two numbers that will be multiplied (896 and 1652 in the example). FIG. 2C shows the result. The upper text box has the two numbers that are being multiplied. The middle text box shows the results of multiplying 892 by 2, 50, 600, and 1000 in separate lines. A plus sign was included to indicate that these numbers will be added together. The answer is displayed in the lower text box.

FIGS. 3A, 3B, and 3C shows a possible method of demonstrating long division with the intermediate step displayed as well as the answer. FIG. 3A shows the calculator once the software program has been started. FIG. 3B shows the two numbers that will be divided, 78.069 and 12.01 in this case. FIG. 3C shows the answer in the upper text box. The numbers being divided are in the middle text box, and the steps involved in long division and the residuals are in the lower text box.

FIGS. 4A, 4B, and 4C shows a possible method of solving a problem with multiple operations with the intermediate step displayed as well as the answer. FIG. 4A shows the calculator once the software program has been started. The user then inputs the equation that they wish to solve (see FIG. 4B). The calculator then performs one part of the equation and re-writes the new update formula below. This continues until there are no symbols left leaving only the answer as illustrated in FIG. 4C.

### Alternative Embodiments

This calculator could also be configured to reveal the intermediate steps followed by the answer one-step at a time. For example, the calculator in the FIG. 2 shows two numbers that will be multiplied (896 and 1652.) Instead of displaying the results of multiplying 892 by 2, 50, 600, and 1000 simultaneously, the user would have to hit a key to move from multiply 892 by 2 to multiplying 892 by 50 and so on until the answer is displayed. In this configuration the benefit that the calculator has for accuracy in mathematics is maintained, and the user exchanges a loss in the speed of calculation for a gain in learning.

### Advantages

From the description above, a number of advantages of some embodiments of my intermediate step calculator become evident:
(a) The user can quickly check their work to verify that the correct answer, and if they made a mistake, they can follow the intermediate steps to find out where they made their error.
(b) The user is reminded of the correct methods used to solve math problems every time they use the calculator.
(c) The user can learn the correct methods of solving math problems by using the calculator.

### Conclusion, Ramification, and Scope

Thus the reader will see that a calculator that displays the answer as well as the calculation's intermediate steps preserves the main advantages offered by a standard electronic calculator (speed and accuracy) while providing the user with valuable information as to how that answer was derived. This will help the user learn mathematics by repeatedly exposing them to the intermediate steps while solving problems. This will also allow the user to check their intermediate steps if they are writing their work on paper. By doing this, the user can find errors more rapidly.

While the above description contains specifications and examples, these should not be construed as limiting the scope of any embodiment, but as an exemplification of the presently preferred embodiments thereof. Many other ramifications and variations are possible within the teachings of the various embodiments. For example, the calculator could be used to solve algebraic problems, geometry problems, financial problems, calculus problems, or any other type of problems currently solved by calculators. The calculator could also be used as a teaching aid. Thus the scope of the invention should be determined by the appended claims and their legal equivalents, and not by the examples given.

1. A machine capable of performing calculations that assists the user in solving problems quickly and accurately while learning the mathematic processes involved in the solution that is comprised of:
a. a method for inputting the numbers and operations into the machine,
b. a display that shows some or all of the steps a human would make to reach the answer,
c. a display that shows the correct answer to the problem.

2. A machine of claim 1 that is capable of displaying the initial equation, the intermediate steps, and the solution to the problem.

3. A machine of claim 1 that is capable of performing the calculations that assists the user in learning mathematics with or without an Internet connection.

4. A machine of claim 1 that can consist of a physical machine designed to perform calculations and display some or all of the intermediate steps of the calculation or software that may be installed on a computer, tablet, smart phone, or other electronic device allowing said device to perform calculations and display some or all of the intermediate steps of the calculation.

5. A machine of claim 1 that has either a single display capable of showing the intermediate steps and the solution or multiple displays capable of showing the intermediate steps and the solution to the user.

6. A machine capable of performing calculations that assists the user in solving math problems quickly and accurately while learning the mathematic processes involved in the solution that is comprised of:
a. a method for inputting the numbers and the operations into the machine,
b. a display that sequentially shows some or all of the steps a human would make to reach the answer,
c. a method for instructing the machine to display the sequential steps either singularly or in groups that a human would make to find the solution,
d. a display that would show the final solution to the problem.

7. A machine of claim 6 that is capable of displaying the initial equation, the intermediate steps and the solution.

8. A machine of claim 6 that is capable of performing the calculations that assists the user in learning mathematics with or without an Internet connection.

9. A machine of claim 6 that can consist of a physical machine designed to perform calculations and display some or all of the intermediate steps of the calculation or software that may be installed on a computer, tablet, smart phone, or other electronic device allowing said device to perform calculations and display some or all of the intermediate steps of the calculation.

10. A machine of claim 6 that has either a single display capable of showing the intermediate steps and the solution or multiple displays capable of showing the intermediate steps and the solution to the user.
